(19) United States
(12) Patent Application Publication
(10) Pub. No.: US 2025/0316718 A1
(43) Pub. Date: Oct. 9, 2025

(54) ELECTROCHEMICAL OXYGEN REDUCTION CATALYST

(71) Applicant: Toyota Jidosha Kabushiki Kaisha, Toyota-shi (JP)

(72) Inventor: Keiichi OKUBO, Susono-shi (JP)

(73) Assignee: TOYOTA JIDOSHA KABUSHIKI KAISHA, Toyota-shi (JP)

(21) Appl. No.: 19/001,436

(22) Filed: Dec. 25, 2024

(30) Foreign Application Priority Data
Apr. 8, 2024 (JP) 2024-061900

(51) Int. Cl. H01M 4/92; H01M 4/88

(52) U.S. Cl. CPC H01M 4/923; H01M 4/926; H01M 4/8807

(57) ABSTRACT

The electrochemical oxygen reduction catalyst includes metal particles and a modifier that modifies the metal particles. The present disclosure relates to an electrochemical oxygen reduction catalyst, wherein the modifier is an organic nitrogen compound, the organic nitrogen compound includes a triazine ring and fluorine bonded to the triazine ring via a covalent bond, and the organic nitrogen compound has a fluorine content of 29 g/eq or less.

### CROSS-REFERENCE TO RELATED APPLICATION

This application claims priority to Japanese Patent Application No. 2024-061900 filed on Apr. 8, 2024, incorporated herein by reference in its entirety.

### BACKGROUND

### 1. Technical Field

The present disclosure relates to electrochemical oxygen reduction catalysts.

### 2. Description of Related Art

Electrochemical oxygen reduction catalysts are widely used in fuel cells, metal-air batteries, etc. Known electrochemical oxygen reduction catalysts include catalysts in which a platinum surface is modified with a melamine compound (WO2019/221156, WO2021/090746). Japanese Unexamined Patent Application Publication No. 2023-121010 (JP 2023-121010 A) discloses a catalyst composition containing a platinum-based catalyst and a salt modifying the platinum-based catalyst. In this catalyst composition, the salt is composed of a specific 1,3,5-triazine derivative cation and a perfluoroalkyl sulfonyl imide anion.

However, the melamine compound is hydrophilic. Therefore, when a catalyst using the melamine compound as a modifier is used, the generated water stays in a catalyst layer. Therefore, transport of oxygen that is a reactant is inhibited, which results in a voltage drop in a high current density region. The catalyst using the salt as disclosed in JP 2023-121010 A also has room for improvement in reducing a voltage drop in a high current density region.

### SUMMARY

As described above, the conventional electrochemical oxygen reduction catalysts have room for improvement in reducing a voltage drop in a high current density region when the catalysts are used. It is therefore an object of the present disclosure to provide an electrochemical oxygen reduction catalyst that reduces a voltage drop in a high current density region.

The inventors completed the present disclosure based on the finding that the use of a compound having a specific amount of fluorine introduced into a side chain of a triazine ring as a modifier can reduce a voltage drop in a high current density region when an electrochemical oxygen reduction catalyst is used.

That is, the gist of the present disclosure is as follows.

### Form 1

An electrochemical oxygen reduction catalyst contains
metal particles and a modifier that modifies the metal particles.
The modifier is an organic nitrogen compound, the organic nitrogen compound contains a triazine ring and fluorine bonded to the triazine ring via a covalent bond, and the organic nitrogen compound has a fluorine content of 29 g/eq or less.

### Form 2

In the electrochemical oxygen reduction catalyst according to Form 1,
the modifier may be a compound given by a general formula (1) or a polymer composed of the compound as a monomer.

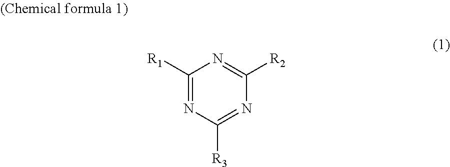

(in the general formula (1), each of R₁, R₂, and R₃ is a hydrogen atom, a halogen atom, or one kind of functional group selected from a group of functional groups consisting of a nitrile group, an amido group, an imine group, an amino group, a thiol group, a hydroxyl group, a sulfo group, a carboxylic acid group, a phosphoric acid group, a ketone group, an aldehyde group, an ester group, an alkoxy group, a phenol group, a cyclopentyl group, a cyclohexyl group, an alkylamino group having 1 to 10 carbon atoms, an alkylsulfonic acid group having 1 to 10 carbon atoms, a perfluoroalkyl group having 1 to 10 carbon atoms, and an alkyl group having 1 to 10 carbon atoms, an alkenylamino group having 2 to 10 carbon atoms, an alkenylsulfonic acid group having 2 to 10 carbon atoms, a perfluoroalkenyl group having 2 to 10 carbon atoms, and an alkenyl group having 2 to 10 carbon atoms, the functional groups each arbitrarily have, in a molecular chain, at least one kind selected from a group consisting of at least one kind of functional group selected from the group of functional groups, an aromatic ring, a heterocyclic ring, an oxygen atom, a sulfur atom, and a nitrogen atom, and at least one of R₁, R₂, and R₃ is a perfluoroalkyl group having 1 to 10 carbon atoms or a perfluoroalkenyl group having 2 to 10 carbon atoms).

### Form 3

In the electrochemical oxygen reduction catalyst according to Form 2,
in the general formula (1), each of R₁, R₂, and R₃ may be a perfluoroalkyl group having 2 to 10 carbon atoms or a perfluoroalkenyl group having 2 to 10 carbon atoms.

### Form 4

In the electrochemical oxygen reduction catalyst according to any of Forms 1 to 3,
the metal particles may be at least one kind selected from a group consisting of platinum particles, platinum alloy particles, and composite particles containing platinum.

The present disclosure can provide an electrochemical oxygen reduction catalyst that reduces a voltage drop in a high current density region.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a graph showing cell voltages after a durability test in 3.2 Acm⁻² for Examples 1 and 2 and Comparative Examples 1 and 2; and

FIG. 2 is a graph showing the voltage retention after a durability test in 3.2 Acm⁻² for Examples 1 and 2 and Comparative Examples 1 and 2.

### DETAILED DESCRIPTION OF EMBODIMENTS

Hereinafter, preferred embodiments of the present disclosure will be described in detail.

The electrochemical oxygen reduction catalyst of the present disclosure (hereinafter also referred to as the catalyst of the present disclosure) includes metal particles and a modifier that modifies the metal particles.

The metal constituting the metal particles may be any metal having oxygen reduction activity (oxygen reduction catalytic ability). Examples of the metal constituting the metal particles include metals such as platinum, ruthenium, iridium, rhodium, palladium, osmium, tungsten, lead, iron, chromium, cobalt, nickel, manganese, vanadium, molybdenum, gallium, aluminum, lanthanum, cerium, praseodymium, neodymium, samarium, gadolinium, and yttrium, and two or more of these metals may be used. The metal may be an oxide, a nitride, a sulfide, a phosphide, or the like. In one embodiment, the metal particles are at least one selected from the group consisting of platinum particles, platinum alloy particles, and composite particles comprising platinum. Examples of the metal other than platinum contained in the platinum alloy and the composite particles containing platinum include the metals (excluding platinum) described above for the metals constituting the metal particles, and two or more of these metals may be included. The elemental ratio of metals other than platinum in the platinum alloy is not particularly limited, and may be from 0.11 atm % to 60 atm %. The particle size of the metallic particles is not particularly limited, and may be 1 nm to 100 nm. In the present disclosure, the particle size of the particles is an average crystallite size measured by an X-ray diffraction method. The particle size of the particles may be 100 to 1000 particles measured by an electron microscope, and the average value thereof may be the average particle size of the particles.

The metal particles may be supported on a support. In this case, the catalyst of the present disclosure includes a support, metal particles supported on the support, and a modifier. The method of supporting the metal particles on the support is not particularly limited, and a conventionally known method can be appropriately employed. The carrier may be a primary particle or a secondary particle. The particle size of the primary particles of the support may be, for example, from 5 nm to 5000 nm. The metal supporting ratio of the metal particles supported on the support is not particularly limited, and may be 1% to 70%, or 18% to 48%. The support may be carbon having conductivity, an oxide, or the like, or a mixture containing these. The carbon may be carbon black (such as acetylene black, Ketjen black, and furnace black), activated carbon, black lead, glassy carbon, graphite, graphene, carbon fiber, carbon nanotube, carbon nitride, sulfurized carbon, and phosphated carbon, channel black, roller black, disk black, oil furnace black, gas furnace black, lamp black, thermal black, vulcan carbon, or a mixture containing two or more of these. The oxide may be titanium oxide, niobium oxide, tin oxide, tungsten oxide and molybdenum oxide, or a mixture containing two or more of these. In one embodiment, the metal particles are supported on a support and the support is carbon.

The modifier is an organic nitrogen compound. The organic nitrogen compound includes a triazine ring and fluorine bonded to the triazine ring via a covalent bond. That is, in the organic nitrogen compound, the triazine ring and the fluorine are bonded via a covalent bond. In the present disclosure, “the triazine ring and the fluorine are bonded via a covalent bond” includes both a case where the fluorine is directly bonded to the triazine ring by a covalent bond, and a case where the fluorine is bonded to the triazine ring by a covalent bond via an optional group. Thus, the modifier of the present disclosure is not in the form of a salt in which the fluorine-containing moiety and the triazine ring-containing moiety are joined by an ionic bond. Hereinafter, an organic nitrogen compound used as a modifier will be described.

The organic nitrogen compound has a fluorine content (fluorine equivalent) of 29 g/eq or less. When the fluorine content of the organic nitrogen compound is less than or equal to 29 g/eq value, the oxygen transportability is improved in the electrochemical oxygen reduction reaction, and a decrease in the voltage in the high current density region is suppressed. In addition, since a specific amount of fluorine is introduced, an increase in the hydrophilicity of the catalyst (particularly, the surface of the support) is suppressed under the use environment of the catalyst. Therefore, oxidation resistance of the catalyst is improved, and a decrease in voltage in the electrochemical oxygen reduction reaction is suppressed. The fluorine content (fluorine equivalent weight) in the organic nitrogen compound is preferably 28 g/eq or less from the viewpoint of suppressing the voltage-drop in the high current density region. The fluorine equivalent weight of the organic nitrogen compound can be calculated from the following formula, and the smaller the value, the larger the fluorine content in the compound. In the case of the polymer, the fluorine equivalent weight of the constituent monomer is regarded as the fluorine equivalent weight of the polymer.

$$Fluorine Equivalent Weight ( g / eq ) = Molecular Weight \text{} ( g / mol ) / Molecular Fluorine Material Weight ( molF / mol )$$

The organic nitrogen compound may have a fluorine content (weight ratio) of 65% by weight or more or 68% by weight or more from the viewpoint of suppressing a voltage drop in a high current density region.

In the organic nitrogen compound, the ratio of the number of fluorine atoms in the total number of atoms in the molecule may be 55% or more and may be 58% or more from the viewpoint of suppressing the voltage drop in the high current density region.

The organic nitrogen compound may have a nitrogen content (nitrogen equivalent) of 145 g/eq or more and may have a nitrogen content of 195 g/eq or more from the viewpoint of suppressing a voltage drop in a high current density range.

In the organic nitrogen compound, the ratio of the number of nitrogen atoms in the total number of atoms in the molecule may be 11.5% or less and may be 8.5% or less from the viewpoint of suppressing the voltage drop in the high current density region.

In one embodiment, the modifier is a compound represented by the general formula (1) or a polymer comprising the compound as a monomer.

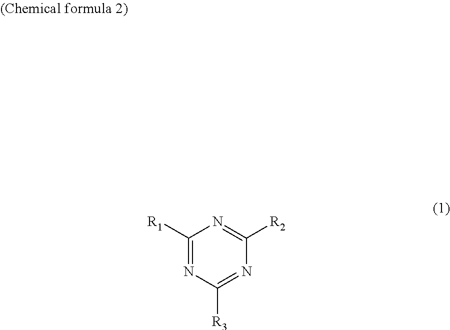

(in the general formula (1), each of R₁, R₂, and R₃ is a hydrogen atom, a halogen atom, or one kind of functional group selected from a group of functional groups consisting of a nitrile group, an amido group, an imine group, an amino group, a thiol group, a hydroxyl group, a sulfo group, a carboxylic acid group, a phosphoric acid group, a ketone group, an aldehyde group, an ester group, an alkoxy group, a phenol group, a cyclopentyl group, a cyclohexyl group, an alkylamino group having 1 to 10 carbon atoms, an alkylsulfonic acid group having 1 to 10 carbon atoms, a perfluoroalkyl group having 1 to 10 carbon atoms, and an alkyl group having 1 to 10 carbon atoms, an alkenylamino group having 2 to 10 carbon atoms, an alkenylsulfonic acid group having 2 to 10 carbon atoms, a perfluoroalkenyl group having 2 to 10 carbon atoms, and an alkenyl group having 2 to 10 carbon atoms, the functional groups may each have, in a molecular chain, at least one kind selected from a group consisting of at least one kind of functional group selected from the group of functional groups, an aromatic ring, a heterocyclic ring, an oxygen atom, a sulfur atom, and a nitrogen atom, and at least one of R₁, R₂, and R₃ is a perfluoroalkyl group having 1 to 10 carbon atoms or a perfluoroalkenyl group having 2 to 10 carbon atoms).

The compound represented by the general formula (1) has a fluorine content (fluorine equivalent) of 29 g/eq or less. Therefore, in the general formula (1), the R₁, R₂, and the R₃ are selected so that the fluorine content of the compound represented by the general formula (1) is equal to or less than 29 g/eq.

In one embodiment, in the general formula (1), at least one of R₁, R₂, and R₃ is a perfluoroalkyl group having 2 to 10 carbon atoms or a perfluoroalkenyl group having 2 to 10 carbon atoms. Each of the R₁, the R₂, and the R₃ may be a perfluoroalkyl group having 2 to 10 carbon atoms or a perfluoroalkenyl group having 2 to 10 carbon atoms. Each of the R₁, the R₂, and the R₃ may be a perfluoroalkyl group having 2 or 3 carbon atoms or a perfluoroalkenyl group having 2 or 3 carbon atoms. In this embodiment, the R₁, the R₂, and the R₃ may be the same or different. The perfluoroalkyl group or perfluoroalkenyl group refers to a group in which all hydrogen atoms of an alkyl chain or an alkenyl chain are replaced with fluorine atoms.

In one embodiment, the compound of general formula (1) is 2,4,6-tris(pentafluoroethyl)-1,3,5-triazine or 2,4,6-tris(heptafluoropropyl)-1,3,5-triazine.

In one embodiment, the modifier may be a polymer comprising a compound represented by the general formula (1) as a monomer. For example, in the general formula (1), when the R₁, the R₂, and the R₃ contain a polymerizable functional group, a polymer having the compound represented by the general formula (1) as a monomer can be formed. Examples of the polymerizable functional group include an addition polymerizable functional group (for example, an ethylenic double bond group included in an alkenyl group) and a condensation polymerizable functional group (for example, an amino group and a carboxylic acid group, and a hydroxyl group and a carboxylic acid group).

The modifier may be a mixture of two or more of the compounds represented by the general formula (1). The modifier may be a mixture of two or more kinds of polymers each containing a compound represented by the general formula (1) as a monomer. The modifier may be a mixture of a polymer containing a compound represented by the general formula (1) and a compound represented by the general formula (1) as monomers.

In one embodiment, the modifier comprises one triazine ring.

The catalyst of the present disclosure can be prepared, for example, by a method such as a dissolution-drying method or a gas phase method, in which metal particles optionally supported on a support and a modifier are prepared.

The catalyst of the present disclosure can be used, for example, by preparing a catalyst ink containing the catalyst of the present disclosure and applying the catalyst ink to a substrate. When the catalyst ink is applied to the substrate and the solvent of the catalyst ink is removed, a catalyst layer is formed on the substrate.

The catalyst ink may include the electrochemical oxygen reduction catalyst, the ionomer, and the solvent. That is, the catalyst ink may include metal particles (which may be supported on a support), modifiers, ionomers, and solvents.

Ionomers are polyelectrolytes having ion exchange groups. Ion exchange groups of the ionomer are not particularly limited, and examples thereof include sulfonic acid, phosphoric acid, and quaternary ammonium cations. The ionomer may be a perfluorocarbon sulfonic acid polymer, an anion exchange polymer, or a polymer based on polyether ether ketone, polybenzimidazole, and the like.

The solvent of the catalyst ink is not particularly limited, and may be, for example, water, alcohol, or a mixed solution of water and alcohol. Examples of the alcohol include, but are not limited to, methanol, diacetone alcohol, ethanol, 1-propanol, 2-propanol (isopropanol), tert-butyl alcohol, ethylene glycol, and propylene glycol.

The catalyst ink can be prepared, for example, by charging a predetermined amount of the above-described components into a container and stirring them using a stirrer.

In forming the catalyst layer, for example, the catalyst ink is coated on a base material such as an electrolyte membrane, a gas diffusion layer (GDL), a gas diffusion layer, or the like, and the catalyst ink after the coating is heated to dry and remove the solvents. The electrolyte membrane may have polytetrafluoroethylene (PTFE) or ion-exchange groups. The gas diffusion layer may be composed of carbon fibers or metal fibers. The gas-diffusion layer may be composed of carbon fibers or metallic fibers having a microporous layer (MPL). The coating thickness may be from 5 μm to 30 μm. The metallic grain content may be in 0.1 mgcm⁻² to 0.6 mgcm⁻².

The catalyst of the present disclosure suppresses a voltage drop in a high current density region in an electrochemical oxygen reduction reaction. Therefore, the catalyst of the present disclosure can be suitably used in fuel cells, metal-air cells, and the like.

Hereinafter, the present disclosure will be described in more detail with reference to Examples. However, the technical scope of the present disclosure is not limited to these examples.

### Preparation of Catalyst Ink

Catalyst inks containing the catalyst and the ionomer in a solvent were prepared. In the catalyst, 2,4,6-tris(pentafluoroethyl)-1,3,5-triazine (Compound 1) (Example 1), 2,4,6-tris(heptafluoropropyl)-1,3,5-triazine (Compound 2) (Example 2), and melamine (Comparative Example 2) were used as modifiers.

### Example 1

The platinum particles were supported on a carbon support. A carbon support supporting platinum particles, a perfluorocarbon sulfonate polymer (EW: 1100) (ionomer) based on Nafion (manufactured by Chemours), 2,4,6-tris(pentafluoroethyl)-1,3,5-triazine (manufactured by Tokyo Chemical Industry Co., Ltd.) (compound 1) (modifier), and a solvent composed of water and diacetone alcohol were charged into a container. These were stirred using a stirrer to prepare a catalyst ink.

### Example 2

A catalyst ink was prepared in the same manner as in Example 1, except that the modifier was changed to 2,4,6-tris(heptafluoropropyl)-1,3,5-triazine (manufactured by Tokyo Chemical Industry Co., Ltd.) (Compound 2).

### Comparative Example 1

A catalyst ink was prepared in the same manner as in Example 1 except that no modifier was used.

### Comparative Example 2

A catalyst ink was prepared in the same manner as in Example 1 except that the modifier was changed to melamine (manufactured by Fujifilm Wako Pure Chemical Industries, Ltd.).

### Preparation of Evaluation Samples

The catalyst inks were coated on polytetrafluoroethylene (PTFE), heated, and the solvents of the catalyst inks were dried and removed to form catalyst layers on PTFE.

The formed catalyst layer was prepared as a cathode catalyst layer, an electrolyte membrane (NafionNR211) was prepared, and an anode catalyst layer containing TEC10E50E (manufactured by Tanaka Kiyoshi Kogyo Co., Ltd.) was prepared as an anode catalyst. The membrane-electrode assembly was prepared by sandwiching the electrolyte membrane between the cathode catalyst layer and the anode catalyst layer and thermocompression bonding them at 130° C. and 3 MPa. Two gas diffusion layers (GDL22BB manufactured by SGL) made of carbon fibers were prepared, and these were placed on both sides of the membrane-electrode assembly to prepare a membrane-electrode gas diffusion layer assembly.

### Evaluation

For the membrane-electrode gas diffusion layer assembly, the following performances before and after the high-potential durability test were evaluated, and the maintenance ratio of the performance after the durability test before and after the durability test was evaluated.

### High Potential Durability Test

It was carried out at 1.3 V, 2 h hold, 80° C. and over-humidification (corresponding to 120% RH).

### Real 1 cm² Cell Valuation

Cell evaluations were performed using respective membrane-electrode gas-diffusion-layer assemblies having 1 cm2 electrode portions. Specifically, the current-voltage properties were evaluated under high humidification conditions (80% RH). The current-voltage properties were obtained in the sweep rate 20 mA/s, Anodicsweep. In addition, the current-voltage property was evaluated by a cell temperature of 80° C., a pressure of 150 kPa_ABS, a cathode gas species of Air, and a cathode gas flow rate of 2.0 L/min.

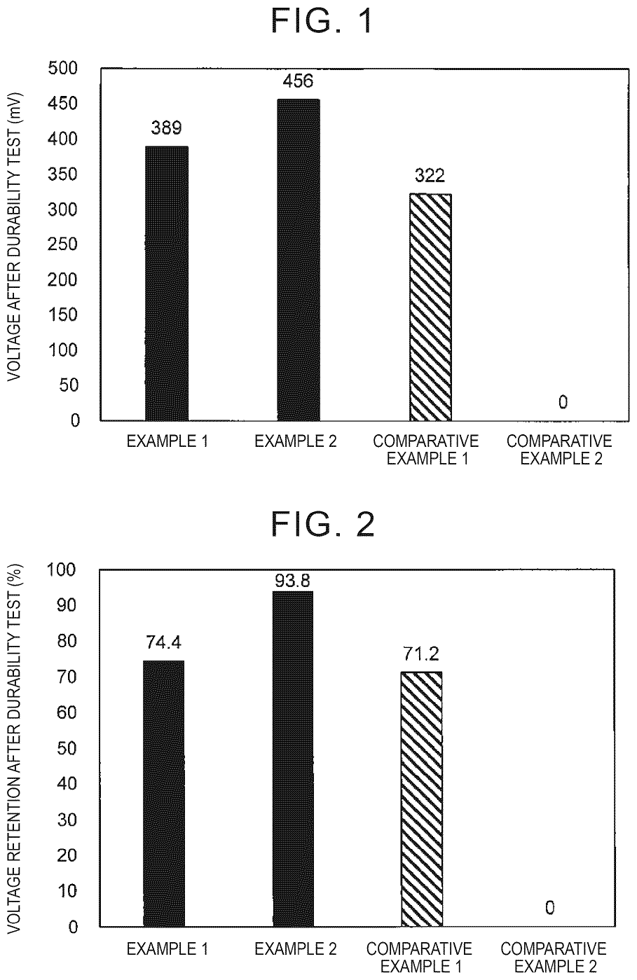

The properties and evaluation results of the modifiers used in Examples 1 and 2 and Comparative Examples 1 and 2 are shown in Table 1. FIG. 1 shows cell voltages after durability tests in 3.2 Acm⁻² for Examples 1 and 2 and Comparative Examples 1 and 2. FIG. 2 shows the voltage retention after the durability test in 3.2 Acm⁻² for Examples 1 and 2 and Comparative Examples 1 and 2.

TABLE 1

| | | | | | Comparative | Comparative |
|---|---|---|---|---|---|---|
| | | | Example 1 | Example 2 | Example 1 | Example 2 |
| Modifier | Type | | Compound 1 | Compound 2 | None | Melamine |
| | Fluorine equivalent | g/eq | 29.0 | 27.9 | — | NA |
| | Fluorine equivalent ratio | Weight % | 65.5 | 68.2 | — | 0 |
| | Nitrogen equivalent | g/eq | 145.0 | 195.0 | — | 21.02 |
| | Ratio of the number of fluorine atoms in | % | 55.6 | 58.3 | | 0 |
| | the total number of atoms | | | | | |
| | Proportion of nitrogen atoms in the total | % | 11.1 | 8.3 | | 40 |
| | number of atoms | | | | | |
| | 0.2 Acm⁻² pre-durability test cell voltage | mv | 831 | 829 | 825 | 838 |
| | Voltage improvement from unmodified | mv | 6 | 4 | 0 | 13 |
| | catalyst (Comparative Example 1) | | | | | |
| Evaluation | 0.2 Acm⁻² cell voltage after endurance test | mv | 829 | 828 | 825 | 839 |
| | Voltage improvement from unmodified | mv | 4 | 3 | 0 | 14 |
| | catalyst (Comparative Example 1) | | | | | |
| | 3.2 Acm⁻² pre-durability test cell voltage | mv | 523 | 486 | 452 | 484 |
| | Voltage improvement from unmodified | mv | 71 | 34 | 0 | 32 |
| | catalyst (Comparative Example 1) | | | | | |
| | 3.2 Acm⁻² cell voltage after endurance test | mv | 389 | 456 | 322 | 0 |
| | Voltage improvement from unmodified | mv | 67 | 134 | 0 | −322 |
| | catalyst (Comparative Example 1) | | | | | |
| | Voltage after endurance test 3.2 Acm⁻² | % | 74.4 | 93.8 | 71.2 | 0.0 |
| | Retention rate | | | | | |

As shown in Tables 1 and 1 and 2, in Examples 1 and 2, a modifier having a fluorine content of 29 g/eq or less was used. In Comparative Example 1, no modifier was used. In Comparative Example 2, the modifier is melamine. In Examples 1 and 2, compared to Comparative Example 1 and Comparative Example 2, the voltage and the voltage retention rate after the durability test at a high current density (3.2 Acm⁻²) were significantly improved.

What is claimed is:

1. An electrochemical oxygen reduction catalyst containing metal particles and a modifier that modifies the metal particles, wherein the modifier is an organic nitrogen compound, the organic nitrogen compound contains a triazine ring and fluorine bonded to the triazine ring via a covalent bond, and the organic nitrogen compound has a fluorine content of 29 g/eq or less.

2. The electrochemical oxygen reduction catalyst according to claim 1, wherein the modifier is a compound given by a general formula (1) or a polymer composed of the compound as a monomer 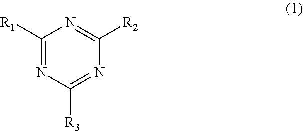
(in the general formula (1), each of R₁, R₂, and R₃ is a hydrogen atom, a halogen atom, or one kind of functional group selected from a group of functional groups consisting of a nitrile group, an amido group, an imine group, an amino group, a thiol group, a hydroxyl group, a sulfo group, a carboxylic acid group, a phosphoric acid group, a ketone group, an aldehyde group, an ester group, an alkoxy group, a phenol group, a cyclopentyl group, a cyclohexyl group, an alkylamino group having 1 to 10 carbon atoms, an alkylsulfonic acid group having 1 to 10 carbon atoms, a perfluoroalkyl group having 1 to 10 carbon atoms, and an alkyl group having 1 to 10 carbon atoms, an alkenylamino group having 2 to 10 carbon atoms, an alkenylsulfonic acid group having 2 to 10 carbon atoms, a perfluoroalkenyl group having 2 to 10 carbon atoms, and an alkenyl group having 2 to 10 carbon atoms, the functional groups each arbitrarily have, in a molecular chain, at least one kind selected from a group consisting of at least one kind of functional group selected from the group of functional groups, an aromatic ring, a heterocyclic ring, an oxygen atom, a sulfur atom, and a nitrogen atom, and at least one of R₁, R₂, and R₃ is a perfluoroalkyl group having 1 to 10 carbon atoms or a perfluoroalkenyl group having 2 to 10 carbon atoms).

3. The electrochemical oxygen reduction catalyst according to claim 2, wherein in the general formula (1), each of R₁, R₂, and R₃ is a perfluoroalkyl group having 2 to 10 carbon atoms or a perfluoroalkenyl group having 2 to 10 carbon atoms.

4. The electrochemical oxygen reduction catalyst according to claim 1, wherein the metal particles are at least one kind selected from a group consisting of platinum particles, platinum alloy particles, and composite particles containing platinum.
